(19) United States
(12) Patent Application Publication
(10) Pub. No.: US 2014/0188664 A1
(43) Pub. Date: Jul. 3, 2014

(54) SURFACING ITEMS THAT SATISFY PURCHASING CONSTRAINTS

(71) Applicant: Christopher Andrew D'Urso, Palo Alto, CA (US)

(72) Inventor: Christopher Andrew D'Urso, Palo Alto, CA (US)

(73) Assignee: eBay Inc., San Jose, CA (US)

(21) Appl. No.: 13/730,391

(22) Filed: Dec. 28, 2012

(51) Int. Cl. G06Q 30/06

(52) U.S. Cl. CPC G06Q 30/0601
USPC 705/26.61

(57) ABSTRACT

Methods and systems to surface, display and/or otherwise present items for sale that satisfy purchasing constraints are described In some example embodiments, the methods and systems access information associated with a purchasing constraint to buy items via an online retail site, determine and/or select items that satisfy the purchasing constraint, such as via information contained by a logistics table, and surface the identified items based on the determination. For example, the methods and systems ma display items available for purchase that satisfy the purchasing constraint via listing of items that satisfy a search query, among other things.

### TECHNICAL FIELD

This application relates generally to information retrieval and, specifically, to surfacing items for sale that satisfy purchasing constraints.

### BACKGROUND

General merchandising of items for sale via a network-based merchandising system is well known. Many websites accessible via the Internet are operated as online stores or auctions. These websites enable users to purchase items that ma be physical items (e.g., an article of clothing), electronic data items (e.g., a downloadable digital media product), or services to be rendered by an affiliated service provider. Often, individuals provide the websites with some or all of the items available for sale. Once items are sold, these individuals may also handle logistics associated with shipping or otherwise sending the physical items to buyers, such as buyers located in or outside of a state, region, or country where the seller is located.

### BRIEF DESCRIPTION OF THE DRAWINGS

The present technology is illustrated by way of example, and not by way of limitation, in the figures of the accompanying drawings,

FIG. 1 is a block diagram illustrating a network architecture of a system to display items for sale that satisfy purchasing constraints, in some example embodiments.

FIG. 2 is a block diagram illustrating a publication system of available products, in some example embodiments.

FIG. 3 is a schematic diagram illustrating an example logistics table.

FIG. 4 is a flow diagram illustrating a method for surfacing items for sale that satisfy purchasing constraints, in some example embodiments,

FIG. 5 is a display diagram illustrating an example user interface that displays items for sale that satisfy purchasing constraints, in some example embodiments.

FIG. 6 shows a diagrammatic representation of a machine in the example form of a computer system within which a set of instructions may be executed to cause the machine to perform any one or more of the methodologies discussed herein.

### DETAILED DESCRIPTION

### Overview

Example methods and systems to surface, display and/or otherwise present items for sale that satisfy purchasing constraints are described. In some example embodiments, the methods and systems access information associated with a purchasing constraint to buy items via an online retail site, determine and/or select items that satisfy the purchasing constraint, such as via information contained by a logistics table, and surface the identified items based on the determination. For example, the methods and systems may display or otherwise indicate items available for purchase that satisfy the purchasing constraint via a list of items available for purchase that satisfy a query or request for certain items, among other things.

Thus, in some example embodiments, the methods and systems described herein enable both sellers and buyers of products and other items via a network-based merchandising system to utilize a logistics table, such as a table that includes entries relating shipping destinations to formulas that calculate costs to ship an item or items to the destinations, in order to determine shipping costs associated with items and to identify items that satisfy purchasing constraints (e.g., constraints associated with cost and/or delivery time periods), among other benefits.

### Example Systems and Methods

In the following description, for purposes of explanation, numerous specific details are set forth in order to provide a thorough understanding of the present disclosure. It may be evident, however, to one skilled in the art that the subject matter of the present disclosure may be practiced without these specific details.

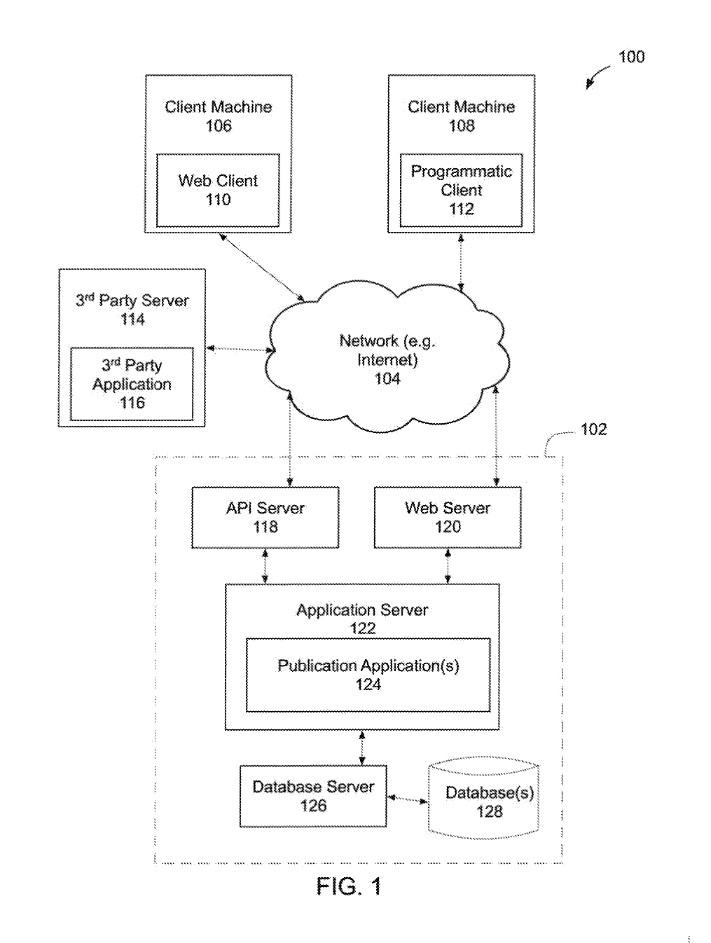

FIG. 1 is a block diagram illustrating a network architecture of a system to surface items for sale that satisfy purchasing constraints, in some example embodiments. For example, the network system 100 may be or include a publication/publisher system 102 where clients may communicate and exchange data within the network system 100. The data may pertain to various functions (e.g., selling and purchasing of items) and aspects (e.g., data describing items listed on the publication/publisher system) associated with the network system 100 and its users. Although illustrated herein as a client-server architecture as an example, other example embodiments may include other network architectures, such as a peer-to-peer or distributed network environment.

A data exchange platform, in an example form of a network-based publication/publisher system 102, may provide server-side functionality, via a network 104 (e.g., the Internet) to one or more clients. The one or more clients may include users that utilize the network system 100 and more specifically, the network-based publication/publisher system 102, to exchange data over the network 104. These transactions may include transmitting, receiving (e g., communicating), and processing data to, from, and regarding content and users of he network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; influence data; and transaction data, among other things.

In various example embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publication/publisher system 102 via a web server 120. The UIs may also be associated with a client machine 108 using a programmatic client 112, such as a client application, or a third party server 114 hosting a third party application 116. It can be appreciated in various example embodiments that the client machines 106, 108, or third party server 114 may be associated with a buyer, a seller, a third party electronic commerce platform, a payment service provider, or a shipping service provider, each in communication with the network-based publication/publisher system 102 and optionally each other. The buyers and sellers may be any one of individuals, merchants, or service providers, among other things.

Turning to the network-based publication/publisher system 102, an application program interface (API) server 118 and the web server 120 are coupled to, and provide programmatic and web interfaces respectively to, one or more application servers 122. The application servers 122 host one or more publication application(s) 124. The application servers 122 are, in turn, shown to be coupled to one or more database server(s) 126 that facilitate access to one r more database(s) 128.

In some example embodiments, the web server 120 and the API server 118 communicate and receive data pertaining to listings, transactions, and feedback., among other things, via various user input tools. For example, the web server 120 may send and receive data to and from a toolbar or webpage on a browser application (e.g., Web client 110) operating on a client machine (e.g., client machine 106). The API server 118 may send and receive data to and from an application (e.g., programmatic client 112 or third party application 116) running on another client machine (e.g., client machine 108 or third party server 114).

The publication application(s) 124 may provide a number of publisher functions and services (e.g., search, listing, payment, etc) to users that access the network-based publication/publisher system 102. For example, the publication application(s) 124 may provide a number of services and functions to users for listing goods and/or services for sale, providing shipping costs or other information associated with listed good and/or services, searching for goods and services, facilitating transactions, and reviewing and providing feedback about transactions and associated users. Additionally, the publication application(s) 124 may track and store data and metadata relating to listings, transactions, and user interactions with the network based publication/publisher system 102.

FIG. 1 also illustrates a third party application 116 that may execute on the third party server 114 and may have programmatic access to the network-based publication/publisher system 102 via the programmatic interface provided by the API server 118. For example, the third party application 116 may use information retrieved from the network-based publication/publisher system 102 to support one or more features or functions on a website hosted by the third party. The third party website may, for example, provide one or more listing, feedback, publisher, or payment functions that are supported by the relevant applications of the network-based publication/publisher system 102.

While the example network system 100 of FIG. 1 employs a client-server architecture, a skilled artisan will recognize that the present disclosure is not limited to such an architecture. The example network system 100 can equally well find application in, for example, a distributed or peer-to-peer architecture system, among other things.

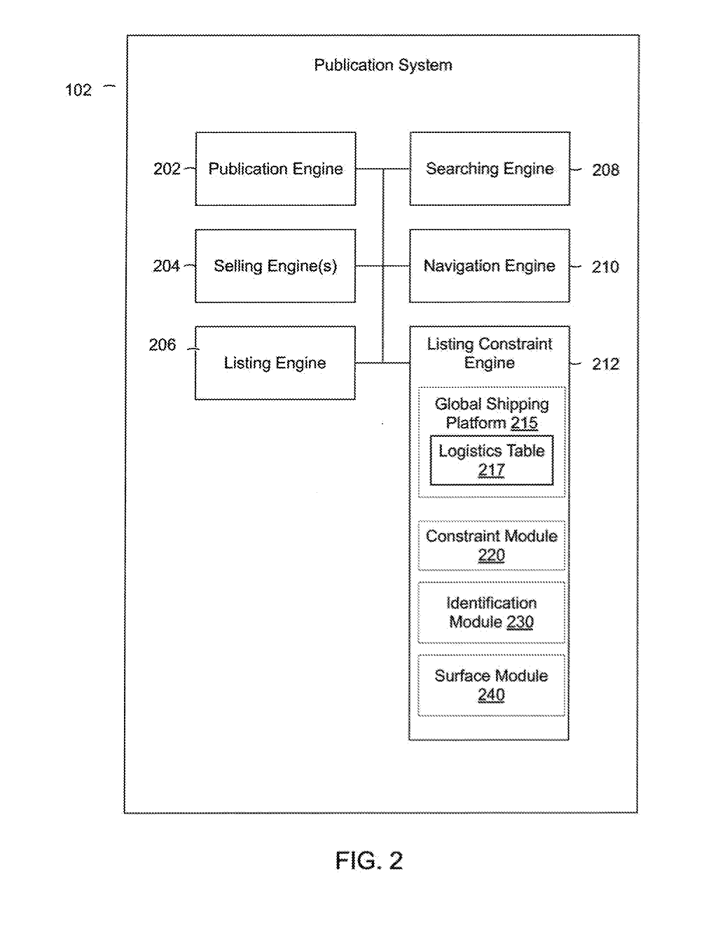

Referring now to FIG. 2, an example block diagram illustrating multiple components that, in some example embodiments, are provided within the publication/publisher system 102 of the network system 100 is shown. The publication/publisher system 102 may be hosted on dedicated or shared server machines (not shown) that are communicatively coupled to enable communications between the server machines. The multiple components, themselves, are communicatively coupled (e,g., via appropriate interfaces), either directly or indirectly, to each other and to various data sources, to allow information to be passed between the components or to allow the components to share and access common data. Furthermore, the components may access the one or more database(s) 128 via the one or more database servers 126, both shown in FIG. 1.

In some example embodiments, the publication/publisher system 102 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. To this end, the publication/publisher system 102 may comprise at least one publication engine 202 and one or more selling engines 204. The publication engine 202 may publish information, such as item listings or product description pages, on the publication/publisher system 102. In sonic example embodiments, the selling engines 204 may comprise one or more auction engines that support auction-format listing and price setting mechanisms (e.g., English, Dutch, Chinese, Double, Reverse auctions, and so on). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may also include fixed price selling engines, among other things.

A listing engine 206 allows sellers to conveniently author listings of items or author publications. In some example embodiments, the listings pertain to goods or services that a user (e.g., a seller) wishes to transact via the publication/publisher system 102. Each good or service is associated with a particular category. The listing engine 206 may receive listing data such as title, description, and aspect name/value pairs. Furthermore, each listing for a good or service may be assigned an item identifier. In some example embodiments, a user may create a listing that is an advertisement or other form of information publication. The listing information may then be stored to one or more storage devices coupled to the publication/publisher system 102 (e.g., databases 128). Listings also may comprise product descriptions that display a product and information (e.g., product title, specifications, reviews, and so on associated with the product. In some example embodiments, the product description page may include an aggregation of item listings that correspond to the product described on the product description page.

A searching engine 208 facilitates searching the network-based publication/publisher system 102. For example, the searching engine 208 enables keyword queries of listings published via the publication/publisher system 102. In some example embodiments, the searching engine 208 receives the keyword queries from a computing device associated with a user and conducts a review of the storage device storing the listing information. The review will enable compilation of a resulting set of listings that may be sorted and returned to the client device (e.g., client machine 106) of the user. The searching engine 208 may record the query (e.g., keywords) and any subsequent user actions and behaviors (e.g., navigations).

A navigation engine 210 enables users to navigate through various categories, catalogs, or inventory data structures according to which listings may be classified within the publication engine 202. For example, the navigation engine 210 allows a user to successively navigate down a category tree comprising a hierarchy of categories until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

A listing constraint engine 212 identifies items fix sale that satisfy a purchasing constraint (e.g., a constraint associated with shipping an item to a buyer within a certain time period and/or below a certain shipping cost), and selects, determines, identifies, presents and/or displays the identified items (or, information associated with the items) that satisfy the purchasing constraints, among other things.

In some example embodiments, the listing constraint engine 212 may include one or more modules and/or components to perform one or more operations of the listing constraint engine 212. The modules may be hardware, software, or a combination of hardware and software, and may be executed by one or more processors. For example, the listing constraint engine 212 may include a constraint module 220, an identification module 230, and a surface module 240.

In some example embodiments, the constraint module 220 is configured and/or programmed to access information associated with a purchasing constraint to buy items via a network-based system. The constraint module 220 may access purchasing constraint information provided by a buyer of an item and/or information determined by the publication system 102 that is associated with the buyer and/or a group of buyers that includes the buyer, among other things. That is, the constraint module 220 may access information directly received from a buyer and/or contextual information that is determined and applied by the publication system 102 during searches performed within the system 102 by the buyer and/or other buyers, among other things.

Example constraint information may include: information identifying a time period within which a buyer wishes to receive a purchased item, information identifying a maximum shipping cost the buyer is willing to pay to receive the purchased item within a specified time period, information identifying a total cost (e.g., cost of the item+cost to ship the item+taxes applied to the item) and/or estimated cost the buyer is willing to pay to the receive the purchased item within the specified time period, and so on.

The constraint module 220 may access the purchasing constraint information during and/or in response to the listing engine 206 presenting a list of items that satisfy certain conditions, such as items that satisfy a search request provided to the searching engine 208 by a buyer.

In some example embodiments, the identification module 230 is configured and/or programmed to identify items that satisfy the purchasing constraint. The identification module 230 may access listing information associated with items available for purchase as well as information associated with the potential buyer, such as information identifying location information (e.g., the buyer's zip code, city, state, country, and so on) associated with the potential buyer, among other things. The identification module 230 may then input the information into a logistics table 217, which may be a table or other data structure that includes one or more entries relating a shipping destination to a cost determination formula associated with shipping the item to the destination within a certain time period.

In order to facilitate the identification and/or selection of items that satisfy shipping constraints, the listing constraint engine 212 may provide and/or access a platform, such as a global shipping platform (GSP) 215 that supports the logistics table 217. For example, the GSP 215 may be a service that facilitates the sale of items to both domestic and international destinations by simplifying the steps to be performed by a seller when selecting shipping destinations. That is, the GSP 215 may receive from a seller information identifying a base cost associated with shipping an item from their location to a domestic warehouse associated with the publishing system and/or the network-based merchandising system, and, using the base cost, deter mine shipping costs to other destinations, such as international destinations in addition, the GSP 215 may include components that handle other formalities associated with shipping items to various destinations, such as customs forms, times, fees, tariffs, foreign trade restrictions, and so on.

The logistics table 217 may be a graphically supported data structure where region or destination specific information, expressed from a regional perspective (using any map or maps), may be compressed and stored in a renormalized form, enabling a quick retrieval of the information, among other things. In some example embodiments, the number of destination regions a seller may specify and/or select is approximately 300, although more or less are possible. Given such a large amount of selected regions, the logistics table 217 provides a generalization scheme to reduce the number of operations often required to determine shipping costs for each of the selected destinations. For example, the logistics table 217 provides such a scheme by providing one or more variables with a cost determination formula, such as a variable associated with the base cost of an item, a variable associated with a seller location, and/or a variable associated with a buyer location, among other things.

An example cost determination formula to calculate the cost to ship an item to a destination or multiple destinations, such as to multiple international destinations, may be as follows:

Shipping Cost=BASE+GLOBAL_CALC(WHS-ZIP, ITEM-DETAILS, DEST-ZIP

where BASE=the base cost in dollars ($),
WHS-ZIP=the zip code of a domestic warehouse.
DEST-ZIP=the zip code of the shipping destination (e.g., buyer location).
ITEM-DETAILS=details associated with the item being shipped, such as size, weight, and so on, and
GLOBAL_CALC−a predetermined algorithm to calculate the cost to ship the item from the domestic warehouse to the destination.

A user, such as a seller of the item, may provide information identifying a base cost associated with shipping an item to a destination, and/or the seller's location information. For example, a seller associated with client machine 106 or client machine 108 may provide or enter information (e.g., a monetary amount) to the listing constraint engine 212, may select one or more options displayed by the listing constraint engine 212 that identify various base costs, and so on. A base cost may be a cost associated with shipping an item via a standard or base method or level of shipping, and may be a set or fixed rate for items of various sizes and/or weights.

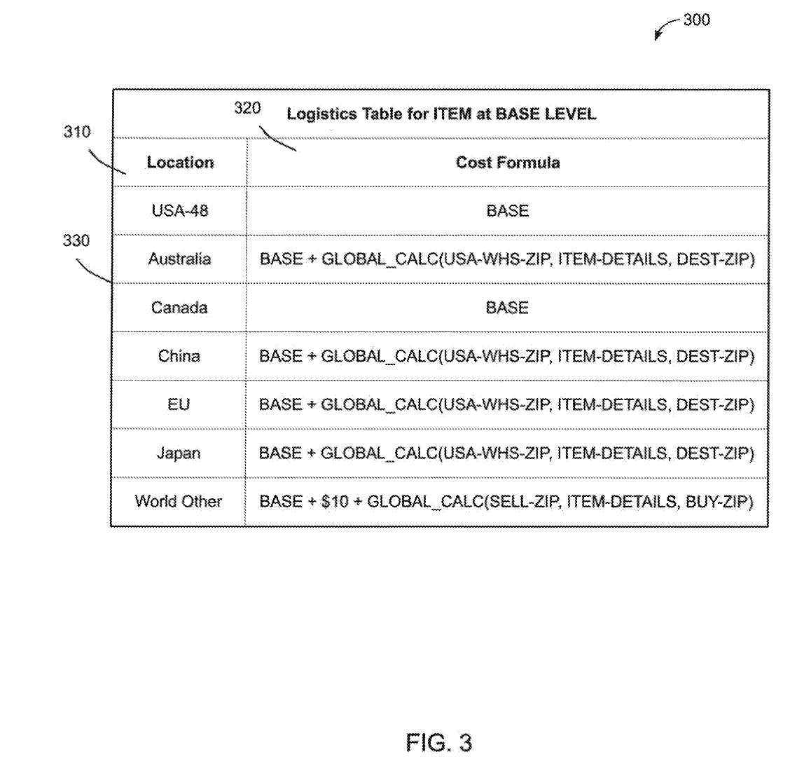

FIG. 3 is a schematic diagram illustrating an example logistics table 300. The logistics table 300 includes various entries 330 that relate information associated with a shipping destination 310 to information associated with a cost formula, such as the cost determination formula described herein. For example, the logistics table 300 may be generated for sellers located in the United States. The table 300 includes entries that relate a domestic shipping destination (e.g., USA-48) and various international shipping destinations (e.g., Australia, China, the EU, and so on) to associated cost formulas. Given a base cost for an item, the logistics table 300 calculates shipping costs for various destinations and returns the calculated costs requesting modules, such as the identification module 230.

Of course, although the logistics table 300 presents certain destinations and cost formulas, a suitable logistics table may include other destinations, formulas, and/or other information associated with determining shipping costs to various destinations. The logistics table 300 may include additional information that may be used to calculate costs associated with shipping an item using various shipping methods or within various timeframes, such as timeframes associated with a purchasing constraint or provided by a potential buyer. For example, the logistics table 300, in response to a received base cost, may calculate the cost to ship an item to various destinations using standard or base level methods of delivery, using expedited methods of delivery (e.g., overnight or 2-day timeframes), and so on.

Thus, the identification module 330 of FIG. 2 may utilize the logistics table 217, which determines the shipping costs within various shipping deadlines or other purchasing constraints to various domestic and/or international destinations associated with potential buyers of the item, when identifying items that satisfy the purchasing constraint.

In some example embodiments, the surface module 240 is configured and/or programmed to display the identified items based on the identification. The surface module 240 may display an indication that the identified items satisfy the purchasing constraint, such as an identifier or other indication that the identified items satisfy the purchasing constraint. For example, the display module 240 may highlight, the identified items or otherwise render the display of the identified items differently than other displayed items, may display the total costs for the items that satisfy the purchasing constraint, and so on.

Although the various components of the publication/publisher system 102 have been discussed in terms of a variety of individual modules and engines, one skilled in the art will recognize that many of the components can be combined or organized in other ways. Furthermore, not all components of publication/publisher system 1 02 have been included in FIG. 1 In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments to aid the reader in an understanding of the systems and methods used herein.

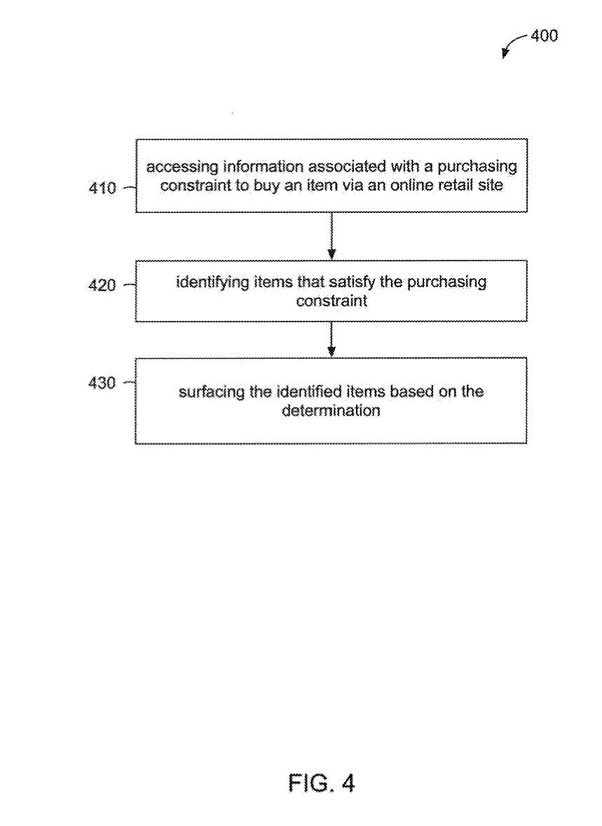

As described herein, the listing constraint engine 212 may, in response to a query for items received from a potential buyer, display a listing of available items that distinguishes items that satisfy a purchasing constraint from other items that do not satisfy the purchasing constraint, among other things. FIG. 4 is a flow diagram illustrating a method 400 for displaying items for sale that satisfy a purchasing constraint, in some example embodiments.

In operation 410, the listing constraint engine 212 accesses information associated with a purchasing constraint to buy items via a network-based system, such as publication/publisher system 102. For example, the constraint module 220 may access information contained by the logistics table 217 that includes entries relating destinations to costs associated with shipping items to the destinations, such as information identifying a shipping deadline constraint associated with shipping an item to a destination by a certain date and a cost constraint associated with a cost for shipping the item to the destination by the certain date.

In operation 420, the listing constraint engine 212 identifies items that satisfy the purchasing constraint. For example, the identification module 230 may identify items that satisfy a shipping deadline constraint and a cost constraint via information obtained from the logistics table 217.

In operation 430, the listing constraint engine 212 surfaces the identified items based on the identification. For example, the surface module 240 may rank, identify, display and/or present the identified items that satisfy the purchasing constraint. The surface module 240 may display a list of items that satisfy the purchasing constraint, such as a list of results that satisfy a search and purchasing constraints, among other things. The list of results may include, for example, product description habilitation (e.g., title, cost, time to buyer, and so on), that displays information associated with the item and/or information identifying how the item satisfies the purchasing constraint.

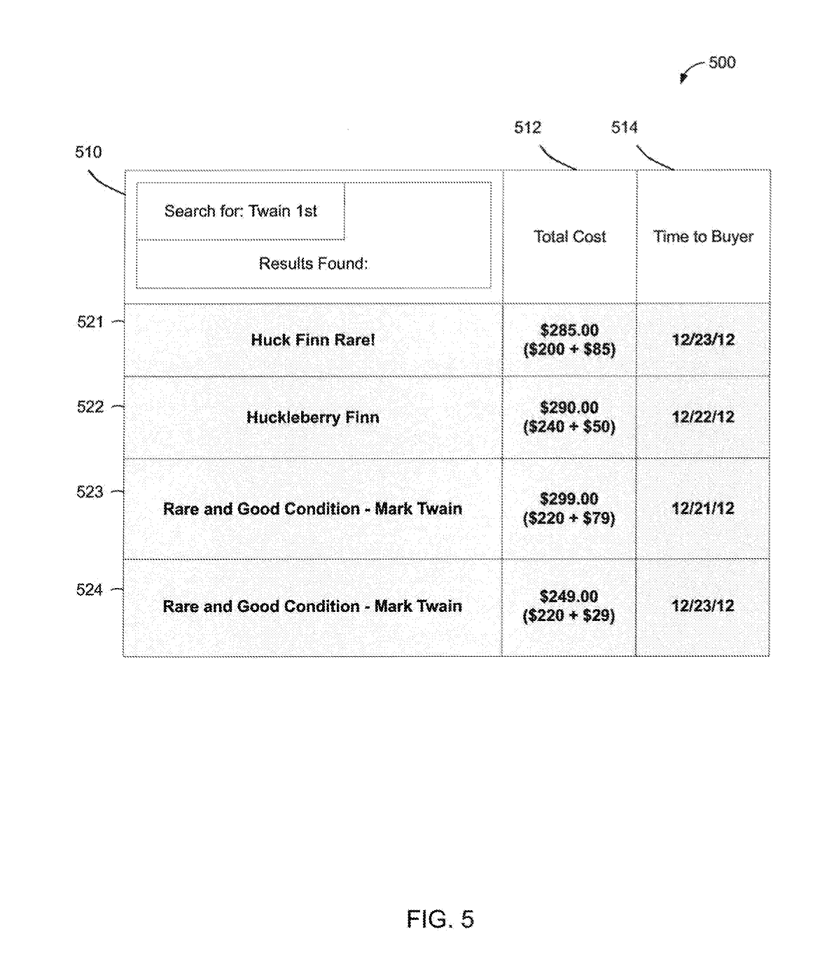

FIG. 5 is a display diagram illustrating an example user interface 500 to display items baaed on purchasing constraints, in some example embodiments. The user interface 500 may display a listing 510 of items that satisfy a received search query, such as a search query for “twain 1^{st}” that is input into a search field of the user interface 500, including items that satisfy purchasing constraints, such as a shipping constraint deadline of “12/23/12” and a cost constraint of “under S300,” that has been determined by the publication system 102 and/or received from a buyer, among other things.

The user interface 500 may display items within the listing 510 that satisfy the search query and the purchasing constraint, such as items 521-524. The user interface 500 may also display information associated with the items that is determined by the logistics table 217, such as total cost information 512, as well as shipping information, such as the time to buyer information 514, among other things. For example, a potential buyer may access the publication system 102 via the web client 110 of the client machine 106 and/or the programmatic client 112 of client machine 108, and perform a search via the search engine 208 for items available for purchase that satisfy the search query of “twain 1^{st},” The search engine 208 may search for items that are associated with the search query and determined and/or predetermined purchasing constraints of a deadline of “12/23/12” and a total cost of “under $300.” For example, the search engine 208 may determine thin these constraints are applicable due to the search being performed a week before the Christmas holiday.

The surface module 240, along with the listing engine 206, may then return a listing 510 of various books or other items that satisfy the purchasing constraint, such as item 521, which has product description information that includes a title “Huck Finn Rare!” that has a total cost of $285.00, which is a summation of the price of the item ($200.00) plus the shipping cost (85) calculated via the logistics table 217, and a expected shipping date of 12/23/12. That is, the surface module 240 may surface and display items deemed to be of most interest to a potential buyer, such as item 521, which satisfies the search query as well as various determined purchasing constraints, among other things.

Thus, in some example embodiments, the listing constraint engine 212 enables a publishing/publication system. 102 to consider purchasing constraints, such as shipping deadlines, total costs, and so on, along with received searches for items available for purchase via a network-based merchandising system, in order provide buyers with a listing of available items that potentially satisfy the constraints, among other things.

That is, the listing constraint engine 212 may provide the techniques described herein in order to present listings of items available for purchase that are focused and/or determined on a buyer's needs and/or desires, such as a need to receive a purchased item by a certain date (e.g., before Christmas or a spouse's birthday), among other benefits.

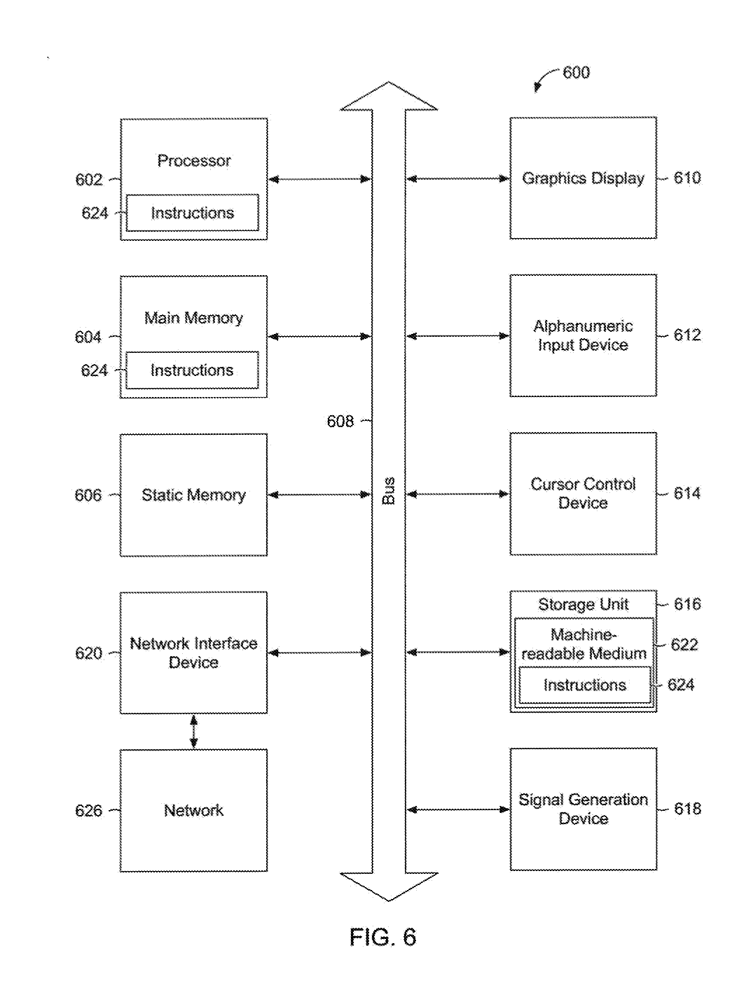

FIG. 6 shows a diagrammatic representation of machine in the exemplary form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as to peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine shall also be taken to include any collection of machines that individually or jointly execute a set for multiple sets) of instructions to perform any one or more of the methodologies discussed herein.

The example computer system 600 includes a processor 602 (e.g., a central processing unit (CPU), a graphics processing unit (GPU), or both), a main memory 604 and a static memory 606, which communicate with each other via a bus 608. The computer system 600 may further include a video display unit 610 (e.g., a liquid crystal display (LCD) or a cathode ray tube (CRT) computer system. 600 also includes an alphanumeric input device 612 (e.g., keyboard), a cursor control device 614 (e.g., a mouse), a disk drive unit 616, a signal generation device 618 (e.g., a speaker), and a network interface device 620.

The disk drive unit 616 includes a machine-readable medium 622 on which is stored one or more sets of instructions (e.g., software 624) embodying any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media. The software 624 may further be transmitted or received over a network 626 via the network interface device 620.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to_{—} solid-state memories, optical and magnetic media, and carrier wave signals.

Certain embodiments are described herein as including logic or a number of components, modules, or mechanisms. Modules may constitute either software modules (e,g., code embodied on a machine-readable medium or in a transmission signal) or hardware modules. A “hardware module” is a tangible unit capable of performing certain operations and may be configured or arranged in a certain physical manner in various example embodiments, one or more computer systems (e,g, a standalone computer system, a client computer system, or a server computer system) or one or more hardware modules of a computer system e.g., processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules in embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

Although the present disclosure has been described with reference to specific exemplary embodiments, it may be evident that various modifications and changes may be made to these embodiments without departing from the broader spirit and scope of the disclosure. Accordingly, the specification and drawings are to be regarded in an illustrative rather than a restrictive sense.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may he utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. [0062j The preceding technical disclosure is intended to be illustrative, and not restrictive. For example, the above-described embodiments (or one or more aspects thereof) may be used in combination with each other. Other embodiments will be apparent to those of skill in the art upon reviewing the above description.

In this document, the terms “a” or “an” are used, as is common in patent documents, to include one or more than one. In this document, the term “or” is used to refer to a nonexclusive or, such that “A or B” includes “A but not B” “B but not A,” and “A and B” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

What is claimed is:

1. A system, comprising:
a constraint module that is configured to access information associated with a purchasing constraint to buy items via a network-based system;
an identification module that is configured to identify items that satisfy the purchasing constraint; and
a surfacing module that is configured to surface the identified items based on the identification.

2. The system claim 1, wherein the constraint module is configured to access information contained by a logistics table that includes entries relating destinations to costs associated with shipping items to the destinations.

3. The system of claim 1, wherein the constraint module is configured to access information that identifies a shipping deadline constraint associated with shipping an item to a destination by a certain date and a cost constraint associated with a cost for shipping the item to the destination by the certain date; and
wherein the identification module is configured to identify items that satisfy the shipping deadline constraint and the cost constraint.

4. The system of claim 1, wherein the constraint module is configured to access information that identifies a shipping deadline constraint associated with shipping an item a destination associated with a buyer of the item; and
wherein the identification module configured to identify items that satisfy the shipping deadline constraint.

5. The system of claim 1, wherein the surfacing module is configured to display a list of results that includes the identified items that satisfy the purchasing constraint.

6. The system of claim 1, wherein the surfacing module is configured to display the identified items along with another item does not satisfy the purchasing constraint.

7. The system of claim 1, wherein the display module is configured to display a list of results that includes product description information associated with identified items that satisfy the purchasing constraint, wherein the product description information includes information associated with the satisfied purchasing constraint.

8. A computer-implemented method, comprising:
accessing information associated with a purchasing constraint to buy items via a network-based system;
identifying items that satisfy the purchasing constraint;
surfacing the identified items based on the identification.

9. The computer-implemented method of claim 8, wherein accessing information associated with a purchasing constraint to buy items via a network-based system includes accessing information contained by a logistics table that includes entries relating destinations to costs associated with shipping items to the destinations.

10. The computer-implemented method of claim 8, wherein accessing information associated with a purchasing constraint to buy items via a network-based system includes accessing information identifying a shipping deadline constraint associated with shipping an item to a destination by a certain date and a cost constraint associated with a cost for shipping the item to the destination by the certain date; and
wherein identifying items that have a total cost that satisfies the purchasing constraint includes identifying items that satisfy the shipping deadline constraint and the cost constraint,

11. The computer-implemented method of claim 8, wherein accessing information associated with a purchasing constraint to buy items via a network-based system includes accessing information identifying a shipping deadline constraint associated with shipping an item to a destination associated with a buyer of the item; and
wherein identifying items that have a total cost that satisfies the applied constraint includes identifying items that satisfy the shipping deadline constraint.

12. The computer-implemented method of claim 8, wherein surfacing the identified items includes displaying a list of results that includes product description information for items that satisfy the purchasing constraint.

13. The computer-implemented method of claim 8, wherein displaying the identified items includes displaying the identified items along with another item does not satisfy the purchasing constraint.

14. The computer-implemented method of claim 8, wherein displaying the identified items includes displaying a list of results that includes product description information associated with identified items that satisfy the purchasing constraint, wherein the product description information includes information associated with the satisfied purchasing constraint

15. A computer-readable storage medium whose contents, when executed by a computing system, cause the computing system to perform operations, comprising:
accessing information associated with a purchasing constraint to buy items via a network-based system;
identifying items that satisfy the purchasing constraint; and
surfacing the identified items based on the identification.

16. The computer-readable storage medium of claim 15, wherein accessing information associated with a purchasing constraint to buy items via a network-based system includes accessing information contained by a logistics table that includes entries relating destinations to costs associated with shipping the item to the destinations.

17. The computer-readable storage medium of claim 15, wherein accessing information associated with a purchasing constraint to buy items via a network-based system includes accessing information identifying a shipping deadline constraint associated with shipping an item to a destination by a certain date and a cost constraint associated with a cost for shipping the item to the destination by the certain date; and
wherein identifying items that have a total cost that satisfies the purchasing constraint includes identifying items that satisfy the shipping deadline constraint and the cost constraint,

18. The computer-readable storage medium of claim 15, wherein accessing information associated with a purchasing constraint to buy items via a network-based system includes accessing information identifying a shipping deadline constraint associated with shipping an item to a destination associated with a buyer of the item; and
wherein identifying items that have a total cost that satisfies the purchasing constraint includes identifying items that satisfy the shipping deadline constraint.

19. The computer-readable storage medium of claim 15, wherein displaying the identified items includes displaying a list of results that includes product description information associated with identified items that satisfy the purchasing constraint.

20. The computer-readable storage medium of claim 15, wherein displaying the identified items includes displaying a list of results that includes product description information associated with identified items that satisfy the purchasing constraint, wherein the product description information includes information associated with the satisfied purchasing constraint.
